(19) United States
(12) Patent Application Publication
(10) Pub. No.: US 2003/0081632 A1
(43) Pub. Date: May 1, 2003

(54) Communications system, in particular for a motor vehicle

(76) Inventors: Klaus Kielhofer, Waldstetten (DE); Andreas Schell, Mi, DE (US)

Correspondence Address: CROWELL & MORING LLP, INTELLECTUAL PROPERTY GROUP, P.O. BOX 14300, WASHINGTON, DC, 20044-4300, US

(21) Appl. No.: 10/259,823

(22) Filed: Sep. 30, 2002

(30) Foreign Application Priority Data
Sep. 29, 2001 (DE) 101 48 326.0

(51) Int. Cl. H04J 3/24

(52) U.S. Cl. 370/473

(57) ABSTRACT

A communications system, in particular for a motor vehicle, has a bus line, a central controller which is connected to the bus line, and at least two control modules which are connected to the bus line. The controller and/or at least one of the control modules is capable of combining messages to be sent into a common message which is transmitted onto the bus line The communications system can be used, for example, for fuel-cell electric vehicles.

This application claims the priority of 101 48 326.0, filed Sep. 29, 2001, the disclosure of which is expressly incorporated by reference herein.

The invention relates to a communications system, in particular for a motor vehicle, having a bus line, a central controller which is connected to the bus line and at least two control modules which are connected to the bus line.

The European laid-open application EP 0 778 179 A2 discloses a communications system in which a plurality of nodes of a communications system are connected to a common bus line. The nodes operate in a master-slave configuration. When a master node fails, one of the slave nodes is operated as a master node.

The international patent publication WO 95/15043 discloses a communications system for a motor vehicle via which a controller exchanges messages with actuator drives. The nodes of the communications system operate in a master-slave configuration.

The German laid-open application DE 196 21 272 A1 discloses a further communications system for a motor vehicle which is embodied as what is referred to as a CAN bus system, actuator drives being assigned to the slave of a master-slave configuration. Control data for the actuator drives are output by the master.

The publication Zeltwanger, Holger “CAN Implementations and Conformance Testing”, CAN in Automation, October 1998, discloses that two CAN buses are connected to one another by means of a gateway.

Known communications systems for motor vehicles are hitting their system limits as a result of the increase in messages to be transmitted. CAN controllers which are currently available on the market can administer a maximum of 15 CAN messages per controller. In fuel-cell electric vehicles, electric drives which are actuated by means of a CAN bus are also used for the secondary assemblies. As a result, the number of messages to be transmitted increases further. The high load on the data bus means that in extreme cases the real-time capability of various systems can no longer be ensured.

The invention is intended to reduce the number of messages to be transmitted in a communications system.

For this purpose, according to the invention, a communications system is provided, in particular for a motor vehicle, with a bus line, a central control which is connected to the bus line and at least two control modules which are connected to the bus line, in which communications system the controller and/or at least one of the control modules has means for combining messages to be sent into a common message which is transmitted onto the bus.

The number of messages on the data bus, and especially the number of reception and acknowledgement messages to be administered in the central controller can be reduced by combining the messages to be sent. This provides capacity in the central controller as the central controller is relieved of administration tasks.

In a development of the invention, the control modules operate in a master-slave configuration and the control module which operates as a master has the means for combining messages for the central controller.

Such an arrangement is advantageous as, in any case, the control module operating as a master checks the messages transmitted by the slaves, and must therefore be designed to process these messages. When the master fails, one of the slaves assumes its function.

In a development of the invention, auxiliary drives and/or actuating elements of a motor vehicle can be actuated by means of the control modules.

Such an embodiment is expedient in particular for fuel-cell electric vehicles. In such vehicles, it is necessary for numerous secondary assemblies, for example an electrically driven water pump of a cooling or heating circuit, to be driven and controlled electrically.

In a development of the invention, the central controller combines messages with setpoint values for the auxiliary drives and/or actuating elements to form a common setpoint value message, and at least one control module having means for combining messages combines actual value messages for the central controller to form a common actual value message.

In this way, the number of actual value and setpoint value messages on the bus line, which are necessary to control the auxiliary drives and the actuating elements, is effectively reduced.

In a development of the invention, the at least one control module having means for combining messages has means for monitoring and checking actual value messages of all the control modules.

As a result, when a control module fails, a corresponding message can be forwarded to the central controller.

In a development of the invention there are provisions for the controller to be connected to a first bus line, and the control modules to be connected to a second bus line, the first and second bus line being connected to one another by means of a gateway.

In this way, the bus load can be reduced further by bringing about a separation between various field bus systems. For example, a separation can be brought about between a fuel-cell system CAN bus and the rest of the vehicle CAN bus by means of a gateway.

In a development of the invention, at least one of the control modules has means for detecting faults on the bus line.

These measures enable the central controller to be relieved of checking and safety functions.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic block diagram of a communications system according to the invention for a motor vehicle according to a first embodiment; and

FIG. 2 is a schematic block diagram of a communications system according to the invention according to a second embodiment of the invention.

### DETAILED DESCRIPTION OF THE DRAWINGS

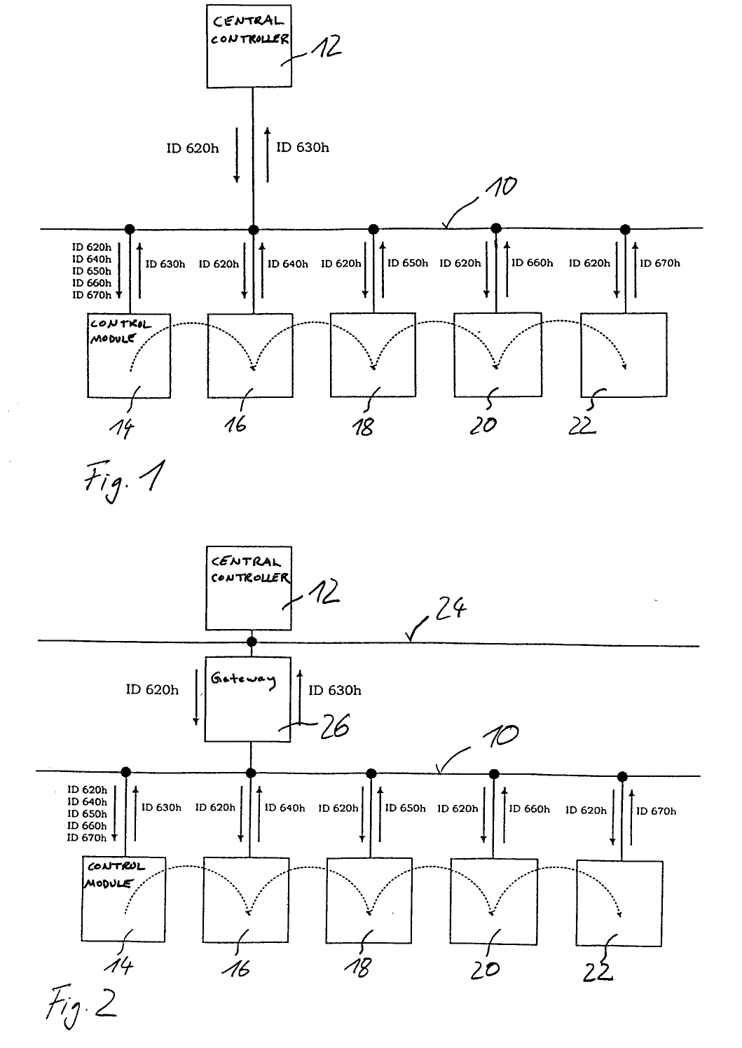

The schematic view in FIG. 1 shows a communications system for a motor vehicle with a CAN bus 10. A central vehicle controller 12 is connected to the CAN bus 10. A plurality of control modules 14, 16, 18, 20 and 22, which are each assigned to auxiliary drives (not shown) of the motor vehicle, are also connected to the CAN bus 10. In a fuel-cell electric vehicle, these auxiliary drives are used, for example, to drive secondary assemblies. Further control modules on the CAN bus 10 may be provided, for example for an ABS controller, the propulsion motor itself, an instrument cluster or other controllers. Particularly in a fuel-cell electric vehicle, the permitted number of messages on the CAN bus 10 is reached quickly. With the full CAN controllers which are currently available on the market, a maximum of 15 CAN messages can be administered per controller. However, in addition to the increased expenditure on circuitry to administer the messages, the load on the CPU from the controllers involved with the administration also increases.

In order to reduce the number of messages on the CAN bus 10, the controller 12 and the control module 14 are provided with means for combining messages. The central controller 12 thus transmits, with the message ID 620h, a setpoint value message onto the CAN bus 10 which relates to all the control modules 14, 16, 18, 20 and 22. Instead of individual setpoint value messages for each of the control modules 14 to 22, only a single setpoint value ID 620h is thus required.

The individual control modules 14 to 22 thus all receive the setpoint value message ID 620h, and each transmit an actual value message onto the CAN bus 10. As will be described later, the control module 14 transmits the actual value message ID 630h, while the control module 16 transmits the actual value message ID 640h, the control module 18 transmits the actual value message ID 650h, the control module 20 transmits the actual value message ID 660h, and the control module 22 transmits the actual value message ID 670h. In the case of the control modules 14 to 22 which are assigned to auxiliary drives, an actual value message of these modules can be composed in each case of a status signal and an actual rotational speed.

The control modules 14 to 22 operate in a master-slave configuration, the control module 14 being configured as a master, and the control modules 16, 18, 20 and 22 being configured as slaves. The master-slave relationship between the control modules 14 to 22 is indicated by the dashed arrows between them.

According to the invention, the control module 14, which operates as a master, has means for combining messages to be sent into a common message which is transmitted onto the bus 10. The control module 14 thus receives the actual values messages ID 640h, ID 650h, ID 660h and ID 670h from the control modules 16, 18, 20 and 22. These actual value messages ID 640h, 650h, 660h and 670h are combined in the control module 14 to form a common actual value message ID 630h. The common actual value message ID 630h is then transmitted onto the CAN bus 10.

As a result, acknowledgement of the actual values is given to the central controller 12 by the control modules 14 to 22 by means of a single actual value message ID 630h. As a result, the central vehicle controller 12 only has to administer one actual value message, specifically the actual value message ID 630h. In comparison with a conventional communications system, the vehicle controller 12 is thus relieved of administration tasks, and more computational capacity for the actual controlling and regulating tasks is available in the vehicle controller 12.

In addition to the combination of the actual value messages of the individual control modules 16, 18, 20 and 22 in the common actual value message ID 630h, the control module 14, which operates as a master, also checks whether one of the control modules 16 to 22 has failed, and signals this to the central vehicle controller 12 with the acknowledgement message. Moreover, each control module 14 to 22 monitors the CAN bus 10 and checks whether all the messages of the modules and the acknowledgement messages are present.

If the control module 14 which operates as a master happens to fail, the slave module with the lowest acknowledgement ID number automatically assumes the master function. In the system in FIG. 1, the control module 16 with the acknowledgement ID number ID 640h would therefore automatically assume the master function for the remaining control modules 18, 20 and 22 if the control module 14 fails.

The schematic representation in FIG. 2 shows a further embodiment of the invention, identical components of the communications system being designated by the same references as in FIG. 1. As in the communications system in FIG. 1, the central vehicle controller 12 and the control modules 14 to 22 are connected to the CAN bus 10. The CAN bus 10 is referred to as a drive CAN bus and is designed for a transmission rate of 500 kbaud.

In contrast to the system in FIG. 1, the communications system illustrated in FIG. 2 is provided with a further CAN bus 24 which is referred to as a vehicle CAN bus and is also designed for a transmission rate of 500 kbaud. The two CAN buses 10 and 24 are separated by means of a CAN gateway 26. The central controller 12 is thus connected directly to the CAN bus 24, and connected to the CAN bus 10 by means of the gateway 26. As is indicated in the illustration in FIG. 2, the setpoint value message ID 620h which is output by the central vehicle controller 12 is transmitted onto the CAN bus 10 via the gateway 26. Conversely, the common actual value message 630 which is generated by the control module 14 is transmitted to the central vehicle controller 12 via the gateway 26.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A communications system for a motor vehicle, comprising:
a bus line;
a central controller coupled to the bus line;
at least two control modules coupled to the bus line; and
wherein at least one of the central controller and one of the control modules includes means for combining messages to be sent into a common message transmitted onto the bus line.

2. The communications system according to claim 1, wherein the at least two control modules operate in a master-slave configuration, the control module operating as a master having the means for combining messages to be sent onto the bus line for the central controller.

3. The communications system according to claim 1, further comprising:
at least one of auxiliary drives and actuating elements of the motor vehicle, said auxiliary drives and actuating elements being operated via the control modules.

4. The communications system according to claim 2, further comprising:
at least one of auxiliary drives and actuating elements of the motor vehicle, said auxiliary drives and actuating elements being operated via the control modules.

5. The communications system according to claim 1, wherein the central controller combines messages with setpoint values for auxiliary drives and/or actuating elements of the motor vehicle to form a common setpoint value message; and
wherein the at least one control module having means for combining messages combines actual value messages for the central controller to form a common actual value message.

6. The communications system according to claim 2, wherein the central controller combines messages with setpoint values for auxiliary drives and/or actuating elements of the motor vehicle to form a common setpoint value message; and
wherein the at least one control module having means for combining messages combines actual value messages for the central controller to form a common actual value message.

7. The communications system according to claim 3, wherein the central controller combines messages with setpoint values for auxiliary drives and/or actuating elements of the motor vehicle to form a common setpoint value message; and
wherein the at least one control module having means for combining messages combines actual value messages for the central controller to form a common actual value message.

8. The communications system according to claim 1, wherein the control module having the means for combining messages further includes means for monitoring and checking actual value messages of any other control module.

9. The communications system according to claim 2, wherein the control module having the means for combining messages further includes means for monitoring and checking actual value messages of any other control module.

10. The communications system according to claim 3, wherein the control module having the means for combining messages further includes means for monitoring and checking actual value messages of any other control module.

11. The communications system according to claim 5, wherein the control module having the means for combining messages further includes means for monitoring and checking actual value messages of any other control module.

12. The communications system according to claim 1, further comprising:
a second bus line;
a gateway coupling the second bus line to the bus line; and
wherein the central controller is connected to the second bus line and the at least two control modules are coupled to the bus line.

13. The communications system according to claim 2, further comprising:
a second bus line;
a gateway coupling the second bus line to the bus line; and
wherein the central controller is connected to the second bus line and the at least two control modules are coupled to the bus line.

14. The communications system according to claim 3, further comprising:
a second bus line;
a gateway coupling the second bus line to the bus line; and
wherein the central controller is connected to the second bus line and the at least two control modules are coupled to the bus line.

15. The communications system according to claim 5, further comprising:
a second bus line;
a gateway coupling the second bus line to the bus line; and
wherein the central controller is connected to the second bus line and the at least two control modules are coupled to the bus line.

16. The communications system according to claim 8, further comprising:
a second bus line;
a gateway coupling the second bus line to the bus line; and
wherein the central controller is connected to the second bus line and the at least two control modules are coupled to the bus line.

17. The communications system according to claim 1, wherein at least one of the two control modules includes means for detecting faults on the bus line.

18. The communications system according to claim 2, wherein at least one of the two control modules includes means for detecting faults on the bus line.

19. The communications system according to claim 3, wherein at least one of the two control modules includes means for detecting faults on the bus line.

20. The communications system according to claim 5, wherein at least one of the two control modules includes means for detecting faults on the bus line.

21. The communications system according to claim 8, wherein at least one of the two control modules includes means for detecting faults on the bus line.

22. The communications system according to claim 12, wherein at least one of the two control modules includes means for detecting faults on the bus line.

23. A communications system for a motor vehicle, comprising:
a first bus line;
a central controller coupled to the first bus line;
a plurality of control modules coupled to the first bus line;
wherein at least one of the central controller and the at least one of the plurality of control modules operate to combine messages that are to be sent into a common message which is then transmitted onto the first bus line.

24. The communications system according to claim 23, wherein the plurality of control modules operate in a master-slave configuration, with one of said plurality of control modules being a master control module and operating to combine messages from the other of said plurality of control modules into the common message for transmission over the bus lines to the central controller.

25. The communications system according to claim 24, wherein the master control module combines actual value messages for the central controller from the plurality of control modules to form a common actual value message.

26. A communications system according to claim 25, wherein the master control module further monitors and checks the actual value messages from the plurality of control modules.

27. A method of operating a controller area network in a motor vehicle having a central controller and at least two control modules coupled to a bus line, the at least two control modules operating to control sub-assemblies of the motor vehicle, the method comprising the acts of:
combining in the central controller messages having set point values for the sub-assemblies of the motor vehicle to form a common setpoint value message sent over the bus line to the at least two control modules;
combining in at least one of the two control modules actual value messages destined for the central controller from the two control modules to form a common actual value message; and
transmitting the common actual value message by the at least one control module to the central controller over the bus line.

28. The method according to claim 27, further comprising the act of:
operating the at least one control module as a master control module; and
operating all other of the at least two control modules as slave control modules.
